(19) United States
(12) Patent Application Publication
(10) Pub. No.: US 2009/0193973 A1
(43) Pub. Date: Aug. 6, 2009

(54) VACUUM AND AMBIENT AIR HEPA FILTRATION SYSTEM

(75) Inventor: Jim Woods, Rosemont (CA)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: Americair Corporation, Mississauga (CA)

(21) Appl. No.: 12/026,139

(22) Filed: Feb. 5, 2008

(51) Int. Cl. B01D 46/00; B01D 50/00

(52) U.S. Cl. 95/286; 55/385.2

(57) ABSTRACT

Combining a HEPA air filtration system and a central vacuum system obtains a synergistic effect of cleaning air particulates in a room. The particulate count of the current invention provides an unexpectedly low result that can at best be described as synergistic.

### FIELD OF THE INVENTION

The present invention is directed to HEPA system that cleans particulates from the air and the floor simultaneously.

### BACKGROUND OF THE INVENTION

### Vacuum Cleaners

Vacuum cleaners include a vacuum cleaner housing interconnected to a floor sweeper. The floor sweeper is formed with a nozzle opening and may include an agitator mounted therein for loosening dirt and debris from a floor surface. A motor may be mounted to either the foot or the housing for producing suction at the nozzle opening. The suction at the nozzle opening picks up the loosened dirt and debris and produces a stream of dirt-laden air which is ducted into the housing. In particular, the dirty air is directed into a collection bag which traps most dust and other particles in a bag made of conventional materials including paper, polymers, meshes, and woven fabrics known to those skilled in the art. After the air passes through the collection bag, the air escapes to the ambient environment through an exhaust system. That vacuum cleaner description is applicable for many vacuum cleaners—conventional upright vacuums and central vacuum systems.

In many central vacuum systems, like Eureka's Yellow Jacket system, the air exhausts to the outside ambient environment through a conduit. Exhausting air into the outside ambient environment is not always possible or permitted. For example, a central vacuum system is normally not installed in hospital settings, hotels, and apartment complexes because the exhausted air may (a) be contaminated with hazardous conditions (for example viral or bacteria environment), and/or (b) contain too many particulates which may violate, for example, EPA compliance.

To confirm the too many particulate issue, the applicant measured the air borne particulates in a conventional sized room, 15′×30′, with a conventional particle reader, for example and not limited to a Met One Laser Particle counter calibrated for readings of 0.3 microns and greater (see http://www.metone.com/particulate.htm). The particle reader was positioned (a) on a conventional end table in the middle of the room prior to Eureka's Yellow Jacket central vacuum system being turned on (known as “Ambient Room”); and (b) in Eureka's Yellow Jacket central vacuum system's exhausts system (known as “Vacuum Exhaust Chamber”). The results were as followed:

| Condition | Particle Count |
|---|---|
| Ambient Room | 297,400 |
| Vacuum Exhaust Chamber | 9,999,999 |

Those particle count results may be why Eureka recommends its exhaust system release its air to the outside environment instead of containing the air in the room. At the same time, that particulate count from certain environments may not be permissible exhausted particulate values.

In view of the particle count in the vacuum exhaust chamber, there has been interest to lower the particulates in vacuum cleaner systems.

In U.S. Pat. No. 6,776,824, Wen discloses an upright vacuum cleaner. That upright vacuum cleaner includes a housing, a floor sweeper, a pair of wheels, an intake opening, an exhaust port, and a handle. The housing divides into upper and lower sections, which cover the internal mechanism of the vacuum, including fan or blower, motor, collection bag, and a supplemental filtration system. By depressing a switch, contaminated or particle laden air positioned exclusively near the intake opening (that air is referred to as “Air A”) enters the upright vacuum through intake opening and is carried by a conduit into a collection bag, which traps most dust and other particles in a bag made of conventional materials including paper, polymers, meshes, and woven fabrics known to those skilled in the art.

The Air A continues through opening in baffle into filtration cartridge or canister. The filtration cartridge or canister includes a passive stage to filter out remaining particles and biological contaminants over a predetermined size (such as 0.3 micron particles); e.g., particles trapped by a HEPA filter. Air A continues through the active stage, which includes one or more agents effective to destroy any bacteria, spores, viruses, or other untrapped biological contaminants, as well as UV or other radiation source capable of sterilizing a given volume of air passing through, or creating ozone to add to the antiseptic effect. Filter unit may be replaced when filled or inactive. After passing through the passive stage, the Air A presumably contains no contaminants, and may return to the atmosphere through the exhaust port, filtering out ozone through water, a metallic mesh, or by use of a catalytic agent to render the ozone inert. The upright vacuum may include additional intake tools such as hoses, wands and the like attachable through a retractable port, which enters through the intake opening.

A similar vacuum system is disclosed in U.S. Pat. No. 5,301,388 to Zeren which is used to pick up hazardous materials.

Problems with Wen's and Zeren's vacuum system are that Wen's and Zeren's alleged HEPA vacuum system fails to clean the particulates in the air positioned away from the intake opening. That failure is applicable for central vacuum systems as well. The air around the intake opening is the only air that is drawn into the vacuum system and is the only air cleaned in such vacuum systems. That limited application can create a room with unacceptable particulate counts.

### HEPA Air Filtration Systems

Americair, Inc., the assignee of this application, is the manufacturer of its AIRWASH HEPA air filtration system. There are three stages of filtration in the AIRWASH air filtration system having a housing. The housing has an air inlet and an air outlet, and within the housing is a fan/motor and a HEPA filtration system. The fan/motor draws air through (a) the air inlet which can have a pre-filter apparatus, (b) a foam pre-filter that removes larger particulates such as dust and dander, (c) high efficiency particulate removal filter media that is laser tested to remove 99.97% of the particles in the air stream down to a size of 0.3 mincrons—particles of concern which are normally in this size range include pollen, household dust, cigarette smoke, bacteria, molds, etc.; (d) an inner blanket (which can be like 1/2 inch) of activated carbon impregnated with non-woven polyester filter material which absorbs additional gaseous contaminants such as odors and toxic fumes; and (e) the air outlet.

The AIRWASH air filtration system can cleanse up to 1,000 cubic feet of air per minute. The applicant conducted a particulate study that compared the number of particulates in a 15′×30′ room prior to operating its AIRWASH air filtration system (referred to as “Ambient Room”) and after its AIRWASH air filtration system operated for 20 minutes (referred to as “20 min Operating”), wherein the particle reader, identified above, was positioned on a conventional end table in the middle of the room. The results are as follows:

| Condition | Particle Count |
|---|---|
| Ambient Room | 297,400 |
| 20 min Operating | 166,400 |

A problem with the AIRWASH air filtration system is that it does not obtain the particulates attached, secured, bound, or trapped to the floor surface—carpets, polymeric flooring or natural flooring. Accordingly there are still particulates in the room that should be removed.

### SUMMARY OF THE INVENTION

The current invention is a combination of a HEPA air filtration system and a central vacuum system to obtain a synergistic effect of cleaning air particulates in a room. The particulate count of the current invention provided an unexpectedly low result that can at best be described as synergistic.

### BRIEF DESCRIPTION OF THE DRAWINGS

FIG. 1 illustrates the rear view of a combined HEPA air filtration system and a central vacuum system 10.

FIG. 2 illustrates the front view of FIG. 1.

FIG. 3 is a top view of FIG. 1 with the hinge door 18 removed.

FIG. 4 is a cross-sectional view of FIG. 3 taken along the lines 4-4.

FIG. 5 is a cross-sectional view of FIG. 3 taken along the lines 5-5 and including a conventional central vacuum tool connected to the housing 12.

FIG. 6 is a cross-sectional view of FIG. 5 taken along the lines 6-6.

FIG. 7 is a cross-sectional view of FIG. 3 taken along the lines 7-7.

FIG. 8 is a cross-sectional view of FIG. 3 taken along the lines 8-8.

### DETAILED DESCRIPTION OF THE INVENTION

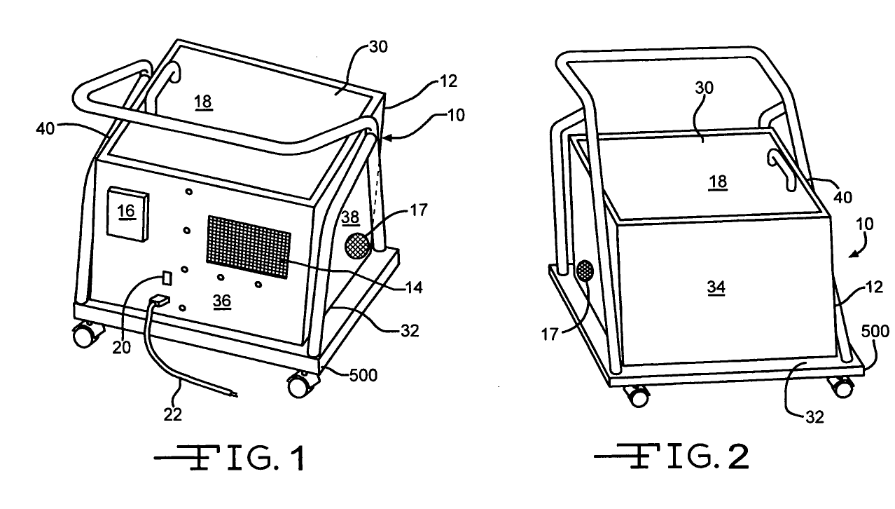

FIGS. 1 and 2 illustrate a combined HEPA air filtration system and a central vacuum system 10. The “combined HEPA air filtration system and central vacuum system” 10 has a housing 12. The housing 12 can be any material sturdy enough to contain a HEPA air filtration system 100 (illustrated in FIG. 3) and a central vacuum system 200 (illustrated in FIG. 3). An example of the housing material is a metal cabinet that is durable and emits no toxins. The housing 12 is normally shaped like a cube and when it is cubed-shaped, the housing 12 has a top surface 30, a bottom surface 32, a front side 34, a rear side 36, a left side 38, and right side 40.

The housing 12 has
an air inlet 14 for the HEPA air filtration system 100 positioned on at least one of the sides 34, 36 (as illustrated but not limited to that surface), 38, 40 and/or top surface 30;
an air outlet 17 for the HEPA air filtration system 100 positioned on at least one of the sides 34, 36, 38 (as illustrated but not limited to that surface), 40, bottom surface 32 and/or top surface 30;
an inlet valve 16 for the central vacuum system 200 positioned on at least one of the sides 34, 36 (as illustrated but not limited to that surface), 38, and/or 40;
a hinge door 18 on the top surface 30 (as illustrated) or one of the sides 34, 36 to allow a person to
   (a) inspect the HEPA air filtration system 100 and/or the central vacuum system 200,
   (b) replace components of or the whole (i) HEPA air filtration system 100 and/or (ii) central vacuum system 200;
a conventional power switch 20 positioned on at least one of the sides 34, 36 (as illustrated but not limited to that surface), 38, 40 and/or top surface 30 to turn on or off (i) the HEPA air filtration system 100 and/or (ii) the central vacuum system 200; and
a power supply outlet 22 positioned on at least one of the sides 34, 36 (as illustrated but not limited to that surface), 38, 40 and/or top surface 30 to interconnect the HEPA air filtration system 100 and/or the central vacuum system 200 to a conventional electrical outlet.

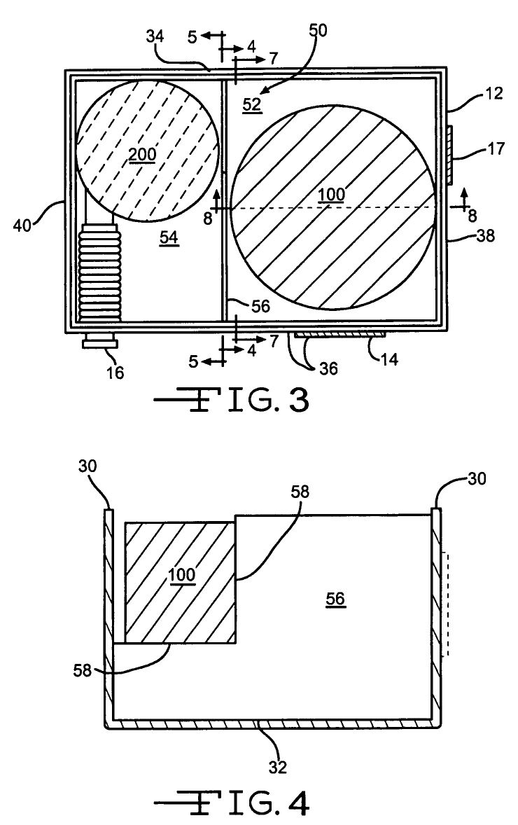

FIG. 3 is a top view of FIG. 1 with the hinge door 18 removed. The housing 12 has an interior 50. The interior 50 is divided into a HEPA air filtration section 52 and a central vacuum section 54. The sections 52, 54 are distinguished by a wall 56. The wall 56 has an opening 58, see FIG. 4, that allows the central vacuum unit's 200 exhaust to enter the HEPA air filtration section 52. As illustrated, the air inlet 14 for the HEPA air filtration system 100 is positioned on at least one of the sides 34, 36 (as illustrated but not limited to that surface), 38, 40 and/or top surface 30 and within the HEPA air filtration section 52. Similarly, the air outlet 17 for the HEPA air filtration system 100 is positioned on at least one of the sides 34, 36, 38 (as illustrated but not limited to that surface), 40, bottom surface 32 and/or top surface 30 and within the HEPA air filtration section 52. Likewise, the inlet valve 16 for the central vacuum system 200 is positioned on at least one of the sides 34, 36 (as illustrated but not limited to that surface), 38, and/or 40 and within the central vacuum section 54.

### Central Vacuum Unit 200

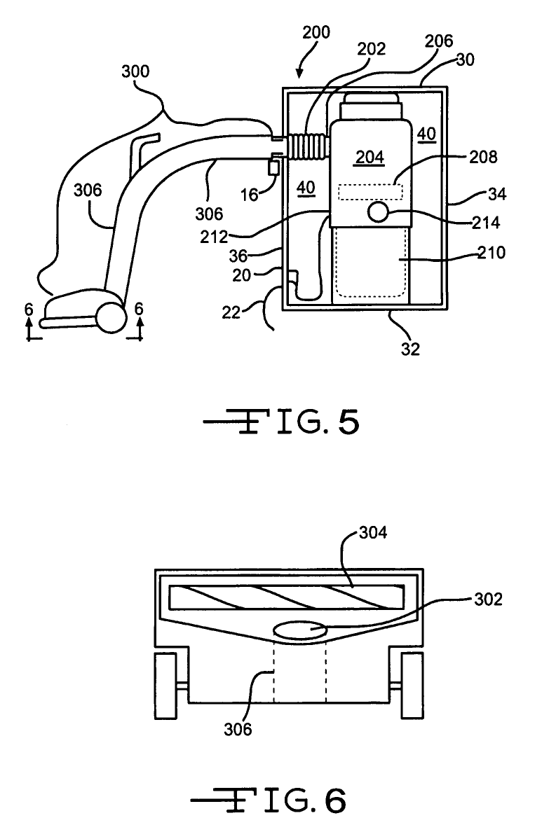

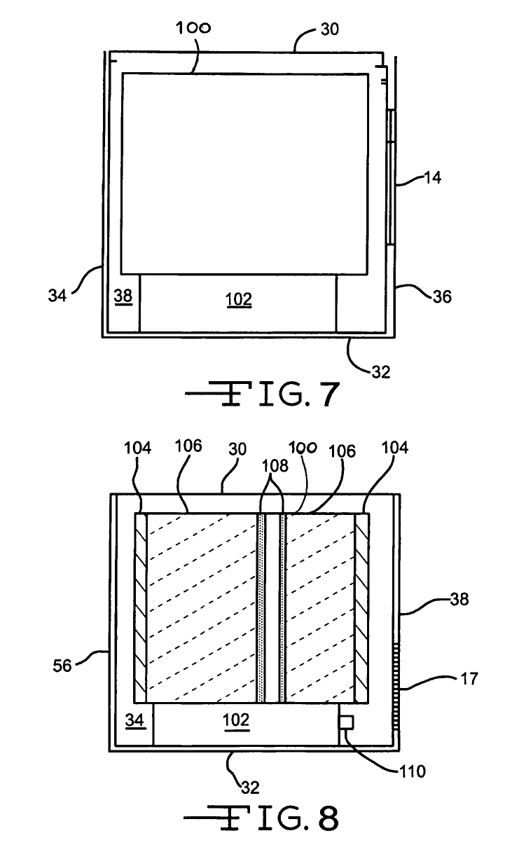

The central vacuum unit 200 is a conventional central vacuum unit, for example and not limited to Eureka's Yellow Jacket central vacuum unit, as illustrated in FIGS. 5 and 6. The central vacuum unit 200 includes the inlet valve 16, a main tubing header 202 from the inlet valve 16 to a power unit 204, a conventional central vacuum tool(s) 300 and the power unit 204. The power unit 204 has a main pipe inlet 206 that receives the main tubing header 202, a fan/motor 208 (in phantom line), a collection unit 210 (in phantom line), a power inlet 212 (interconnected to the power supply outlet 22 and the power switch 20) and an exhaust outlet 214.

Conventional central vacuum tools 300 interconnect to the power unit 204 through the inlet valve 16. An example of the conventional central vacuum tool(s) 300 includes and is not limited to a powerbrush unit. A powerbrush unit is formed with a nozzle opening 302 and may include an agitator 304 mounted therein for loosening dirt and debris from a floor surface.

The fan/motor 208 produces suction at the nozzle opening 302. The suction at the nozzle opening 302 picks up the loosened dirt and debris from the flooring (carpet, natural flooring, and/or polymeric flooring) and produces a stream of dirt-laden air which is ducted into the power unit 204 through a powerbrush conduit 306, the inlet valve 16, the main tubing header 202, and the main pipe inlet 206. In particular, the dirty air is directed into the collection unit 210 which traps most dust and other particles in a bag (and/or filter) made of conventional materials including paper, polymers, meshes, and woven fabrics known to those skilled in the art. After the air passes through the collection bag, the air is released through the exhaust outlet 214 in the housing's interior 50, in particular in the central vacuum section 54, and towards the HEPA air filtration section 52.

Most of the above-identified operation of how the central vacuum unit 200 operates is in the public domain in relation to this patent application. What is novel in this application is that the exhausted air is released in the interior of a housing (contrary to the teachings of how to use the central vacuum unit by its manufacturers) and the power unit 204 is contained in a housing that accommodates the HEPA air filtration device 100 and the power unit 204 and not much more, which again contrary to the instructions for the manufacturer of the central vacuum units.

Recall the applicant measured the air borne particulates in a conventional sized room, 15′×30′ (which can be smaller or larger) with a conventional particle reader, for example and not limited to a Met One Laser Particle counter calibrated for readings of 0.3 microns and greater (see http://www.metone.com/particulate.htm). The particle reader was positioned (a) on a conventional end table in the middle of the room prior to Eureka's Yellow Jacket central vacuum system being turned on (known as “Ambient Room”); and (b) in Eureka's Yellow Jacket central vacuum system's exhaust outlet 214 (known as “Vacuum Exhaust Chamber”). The results were as followed:

| Condition | Particle Count |
|---|---|
| Ambient Room | 297,400 |
| Vacuum Exhaust Chamber | 9,999,999 |

Those particle count results may be why Eureka recommends its exhaust system release its air to the outside environment. The present invention however wants to keep those particulates in the housing's interior 50.

### HEPA Air Filtration System 100

The HEPA air filtration 100 receives (a) the air released from the central vacuum's exhaust outlet 214 and (b) the ambient air in the room. The ambient air in the room enters the HEPA air filtration device 100 through the air inlet 14; while the air released from the central vacuum's exhaust outlet 214 is directed toward the HEPA air filtration system 100 through the wall's opening 58.

Both (a) the air released from the central vacuum's exhaust outlet 214 and (b) the ambient air in the room are drawn into the HEPA air filtration device 100 by the HEPA air filtration device's fan/motor 102. The fan/motor 102 draws the air through (a) a foam pre-filter 104 that removes larger particulates such as dust and dander, (b) high efficiency particulate removal filter media 106 that is laser tested to remove 99.97% of the particles in the air stream down to a size of 0.3 microns—particles of concern which are normally in this size range include pollen, household dust, cigarette smoke, bacteria, molds, etc.; (c) an inner blanket 108 (which can be like ½ inch) of activated carbon impregnated with non-woven polyester filter material which absorbs additional gaseous contaminants such as odors and toxic fumes; and (d) HEPA air filtration device's air outlet 110 to the system's 10 air outlet 17. The air that is released from the system's 10 air outlet 17 into the room that the system 10 is positioned therein, not an environment outside the room.

Recall the AIRWASH air filtration system, by itself, can cleanse up to 1,000 cubic feet of air per minute. The applicant conducted a particulate study that compared the number of particulates in a 15′×30′ room prior to operating its AIRWASH air filtration system (referred to as “Ambient Room”) and after its AIRWASH air filtration system operated for 20 minutes (referred to as “20 min Operating”), wherein the particle reader, identified above, was positioned on a conventional end table in the middle of the room. The results were as follows:

| Condition | Particle Count |
|---|---|
| Ambient Room | 297,400 |
| 20 min Operating | 166,400 |

### Synergistic Effect

The synergistic effect of the “combined HEPA air filtration system and central vacuum system” 10 are as follows:
1. The system 10 cleans at least double the amount of air in cubic feet per minute that a comparable AIRWASH air filtration system can handle.
2. The system 10 cleans more than double the amount of air in cubic feet per minute that any vacuum cleaner can, and/or HEPA filtered vacuum cleaner.
3. The applicant conducted a particulate study that compared the number of particulates in a 15′×30′ (which could have been smaller and/or larger) room prior to operating its “combined HEPA air filtration system and central vacuum system” 10 (referred to as “Ambient Room”) and after its “combined HEPA air filtration system and central vacuum system” 10 operated for 20 minutes (referred to as “20 min Synergistic Effect”), wherein the particle reader, identified above, was positioned on a conventional end table in the middle of the room. The results are as follows:

| Condition | Particle Count |
|---|---|
| Ambient Room | 297,400 |
| 20 min Synergistic Effect | 0 to 100 |

The incredibly low particle counts of 0 to 100 (less than 100,000, less than 50,000, less than 10,000, less than 5,000) can not be explained by a simple combination of these two known devices. As such it must be determined these particle counts are a synergistic effect of these two known devices being combined in a single housing unit.

To further confirm the synergistic effect, it should be noted that Eureka (and other central vacuum cleaner manufacturers) in its operation manual clearly discloses that its central vacuum product should not be positioned in confined spaces, like a housing, and in particular wrote, “DO NOT exhaust into a concealed area” like a housing. Despite those negative teachings, the applicant discovered it can significantly and synergistically decrease the particulate counts in a room by combining these two known machines in a manner that should be adverse to at least one of the manufacturer's explicit instructions to the proper use of the device.

### Alternative Embodiment

The housing 12 can be on a cart 500 as illustrated in FIG. 1. That way the “combined HEPA air filtration system and central vacuum system” 10 can be transported from room to room to obtain the desired particle count in each room.

It is intended that the above description of the preferred embodiments of the structure of the present invention and the description of its operation are but one or two enabling best mode embodiments for implementing the invention. Other modifications and variations are likely to be conceived of by those skilled in the art upon a reading of the preferred embodiments and a consideration of the appended claims and drawings. These modifications and variations still fall within the breadth and scope of the disclosure of the present invention.

We claim:

1. A room cleaning device comprising:
a HEPA air filtration system and a central vacuum power unit in a housing (A) having (i) an air inlet for the HEPA air filtration system, (ii) an air outlet for the HEPA air filtration system, and (iii) an inlet valve for the central vacuum system, and (B) positioned in a conventional sized room;
the central vacuum power unit (a) interconnects to a central vacuum cleaning tool having a nozzle opening through the inlet valve, (b) has a first fan/motor that produces suction at the nozzle opening, and the suction at the nozzle opening picks up loosened dirt and debris from the flooring and produces a stream of dirt-laden air which is ducted into the power unit's collection unit which traps most dust and other particles, (c) has an exhaust outlet that directs the air that passes through the collection unit towards the HEPA air filtration system;
the HEPA air filtration system has a second fan/motor that draws (i) the air released from the central vacuum power unit's exhaust outlet and (ii) the ambient air in the room through the air inlet through a high efficiency particulate removal filter media that is laser tested to remove 99.97% of the particles in the air stream down to a size of 0.3 microns, and the air outlet wherein the particulate count of the air in the conventional sized room after 20 minutes of operating the room cleaning device is less than 100,000 particles.

2. The room cleaning device of claim 1 wherein the collection unit is a bag made of materials selected from the group consisting of paper, polymers, meshes, and woven fabrics.

3. The room cleaning device of claim 1 wherein the housing had a wall that established a HEPA air filtration system section and a central vacuum power unit section in the interior of the housing.

4. The room cleaning device of claim 1 wherein the housing is positioned on a cart.

5. The room cleaning device of claim 3 wherein the wall has an opening that allows the air released from the central vacuum power unit's exhaust outlet to be drawn into the HEPA air filtration system.

6. The room cleaning device of claim 1 wherein the conventional sized room is smaller than 50 feet×50 feet.

7. The room cleaning device of claim 1 wherein the second fan/motor draws the air through a foam pre-filter that removes larger particulates prior to the air entering the high efficiency particulate removal filter media.

8. The room cleaning device of claim 1 wherein the second fan/motor draws the air through an inner blanket of activated carbon impregnated with non-woven polyester filter material that absorbs gaseous contaminants after exiting the high efficiency particulate removal filter media.

9. A method of decreasing particulates in a room comprising:
providing power to a HEPA air filtration system and a central vacuum power unit in a housing (A) having (i) an air inlet for the HEPA air filtration system, (ii) an air outlet for the HEPA air filtration system, and (iii) an inlet valve for the central vacuum system, and (B) positioned in a conventional sized room;
utilizing the central vacuum power unit that (a) interconnects to a central vacuum cleaning tool having a nozzle opening through the inlet valve, (b) has a first fan/motor that produces suction at the nozzle opening, and the suction at the nozzle opening picks up loosened dirt and debris from the flooring and produces a stream of dirt-laden air which is ducted into the power unit's collection unit which traps most dust and other particles, (c) has an exhaust outlet that directs the air that passes through the collection unit towards the HEPA air filtration system;
operating the HEPA air filtration system that has a second fan/motor that draws (i) the air released from the central vacuum power unit's exhaust outlet and (ii) the ambient air in the room through the air inlet through a high efficiency particulate removal filter media that is laser tested to remove 99.97% of the particles in the air stream down to a size of 0.3 microns, and the air outlet wherein the particulate count of the air in the conventional sized room after 20 minutes of operating the room cleaning device is less than 100,000 particles.

10. The method of decreasing particulates in a room of claim 9 wherein the collection unit is a bag made of materials selected from the group consisting of paper, polymers, meshes, and woven fabrics.

11. The method of decreasing particulates in a room of claim 9 wherein the housing had a wall that established a HEPA air filtration system section and a central vacuum power unit section in the interior of the housing.

12. The method of decreasing particulates in a room of claim 9 wherein the housing is positioned on a cart.

13. The method of decreasing particulates in a room of claim 11 wherein the wall has an opening that allows the air released from the central vacuum power unit's exhaust outlet to be drawn into the HEPA air filtration system.

14. The method of decreasing particulates in a room of claim 9 wherein the conventional sized room is smaller than 50 feet×50 feet.

15. The method of decreasing particulates in a room of claim 9 wherein the second fan/motor draws the air through a foam pre-filter that removes larger particulates prior to the air entering the high efficiency particulate removal filter media.

16. The method of decreasing particulates in a room of claim 9 wherein the second fan/motor draws the air through an inner blanket of activated carbon impregnated with non-woven polyester filter material that absorbs gaseous contaminants after exiting the high efficiency particulate removal filter media.

17. A room cleaning device comprising:
a HEPA air filtration system and a central vacuum power unit in a housing (A) having (i) an air inlet for the HEPA air filtration system, (ii) an air outlet for the HEPA air filtration system, (iii) an inlet valve for the central vacuum system, and (iv) at least one fan/motor, and (B) positioned in a conventional sized room;
the central vacuum power unit (a) interconnects to a central vacuum cleaning tool having a nozzle opening through the inlet valve, (b) allows the fan/motor produce suction at the nozzle opening, and the suction at the nozzle opening picks up loosened dirt and debris from the flooring and produces a stream of dirt-laden air which is ducted into the power unit's collection unit which traps most dust and other particles, (c) has an exhaust outlet that directs the air that passes through the collection unit towards the HEPA air filtration system;
the HEPA air filtration system allows the fan/motor draw (i) the air released from the central vacuum power unit's exhaust outlet and (ii) the ambient air in the room through the air inlet through a high efficiency particulate removal filter media that is laser tested to remove 99.97% of the particles in the air stream down to a size of 0.3 microns, and the air outlet wherein the particulate count of the air in the conventional sized room after 20 minutes of operating the room cleaning device is less than 100,000 particles.

18. The room cleaning device of claim 17 wherein the housing had a wall that established a HEPA air filtration system section and a central vacuum power unit section in the interior of the housing.

19. The room cleaning device of claim 17 wherein the housing is positioned on a cart.

20. The room cleaning device of claim 18 wherein the wall has an opening that allows the air released from the central vacuum power unit's exhaust outlet to be drawn into the HEPA air filtration system.
